(19) United States
(12) Patent Application Publication
(10) Pub. No.: US 2025/0348963 A1
(43) Pub. Date: Nov. 13, 2025

(54) CONTRACT ADVISOR

(71) Applicant: Wells Fargo Bank, N.A., San Francisco, CA (US)

(72) Inventors: Vishrut Lugani, Walnut Creek, CA (US); Ajith K. Puthiyottil, San Ramon, CA (US); Chakrapani Venkatesan, Antioch, CA (US)

(21) Appl. No.: 18/662,015

(22) Filed: May 13, 2024

(51) Int. Cl. G06Q 50/18

(52) U.S. Cl. CPC G06Q 50/18

(57) ABSTRACT

A computer system and method for managing a contract by receiving and analyzing attributes to classify the agreement based on its type. Proposed clause inputs are received, analyzed, and classified, considering their relationship to a document family and whether they pertain to an amendment or new agreement. Revised clause language is generated by identifying and reformatting previously utilized legal clauses to align with the document family and propose revisions or new clauses. Potential risk exposure is evaluated based on risk management parameters or regulatory requirements, and the revised clauses are reformatted to address identified risks. This system enables efficient contract management, ensuring appropriate classification, tailored clause generation, and risk mitigation.

### BACKGROUND

Large organizations often deal with a multitude of contracts encompassing different products, instruments, and services provided to their customers. These contracts typically contain numerous legal clauses and terms that are negotiated with counterparties. While it is important for these organizations to have a robust system in place to verify and approve these clauses and terms to mitigate potential risks to the organization, ensuring the accuracy and compliance of these clauses and terms poses a significant challenge.

Traditionally, these risks are addressed through manual review and approval of contractual elements by a legal team to ensure compliance with regulatory requirements and to minimize the organization's exposure to risk. However, the manual review process can be time-consuming and error-prone, leading to delays in contract generation and potentially overlooking important risk factors.

### SUMMARY

Embodiments of the disclosure are directed to managing a contract, including receiving attributes regarding a proposed agreement, analyzing the attributes to classify the proposed agreement according to an agreement type, receiving a proposed clause input for the proposed agreement, analyzing the proposed clause input, including classifying the proposed clause input according to a clause type, determining whether the proposed clause input relates to a family of documents, determining whether the proposed clause input relates to an amendment to a pre-existing agreement or a new agreement, generating proposed revised clause language, including, identifying a previously utilized legal clause according to the clause type and the agreement type, reformatting the previously utilized legal clause to incorporate a characteristic associated with the family of documents, reformatting the previously utilized legal clause to read as either a proposed revision to a pre-existing clause of the pre-existing agreement or a proposed new clause to the new agreement, and evaluating a potential risk exposure associated with the proposed revision or the proposed new clause based on at least one of a risk management parameter or a regulatory requirement, and reformatting the proposed revision or the proposed new clause to address the potential risk exposure.

Embodiments also encompass a computer system for managing a contract. This computer system includes one or more processors and non-transitory computer-readable storage media. When executed by the processors, the instructions stored in the media enable the computer system to perform the following steps: receiving attributes regarding a proposed agreement; analyzing the attributes to classify the proposed agreement according to an agreement type; receiving a proposed clause input for the proposed agreement; analyzing the proposed clause input, which includes classifying it according to a clause type; determining whether the proposed clause input relates to a family of documents; determining whether the proposed clause input relates to an amendment to a pre-existing agreement or a new agreement; generating proposed revised clause language, which involves identifying a previously utilized legal clause based on the clause type and the agreement type, and reformatting the previously utilized legal clause to incorporate a characteristic associated with the family of documents; reformatting the previously utilized legal clause to read as either a proposed revision to a pre-existing clause of the pre-existing agreement or a proposed new clause to the new agreement; and evaluating a potential risk exposure associated with the proposed revision or the proposed new clause based on at least one of a risk management parameter or a regulatory requirement, and reformatting the proposed revision or the proposed new clause to address the potential risk exposure.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example of a computer system for managing contracts.

FIG. 2 shows an example server device of the computer system of FIG. 1.

FIG. 3 shows an example generative transformer of the server device of FIG. 2.

FIG. 4 shows an example feed forward deep learning model employed by the generative transformer of FIG. 3.

FIG. 5 shows an example recurrent deep learning model employed by the generative transformer of FIG. 3.

FIG. 6 shows an example method of managing contracts.

FIG. 7 shows example physical components of the server device of FIG. 2.

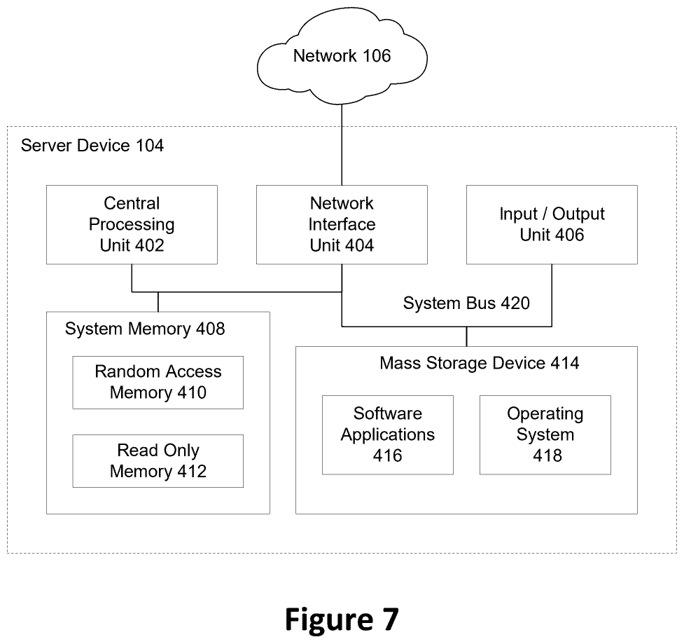

### DETAILED DESCRIPTION

This disclosure relates to managing contracts in the context of contracts.

In order to mitigate potential risks to the organization and ensure compliance with regulations, organizations must verify and approve the clauses and terms of contracts. Traditionally, this process has relied on manual review by an organization's legal team, which can be time-consuming, resource-intensive, and prone to errors.

To address these challenges, the present disclosure leverages automation through the utilization of artificial intelligence and machine learning algorithms. By incorporating these technologies, the concept enhances the contract management process, by enabling faster review and approval and reducing the time and effort required by the legal team. It also improves consistency in the review process and minimizes the occurrence of human errors. Through the use of machine learning algorithms, the system can provide users with suggested and approved language for clauses and terms within an agreement. Additionally, the system allows for simultaneous preparation of agreements within a family of agreements by separate business units, while ensuring consistency across all the agreements.

The utilization of artificial intelligence and machine learning enables the system to analyze attributes of proposed agreements and classify them according to their agreement type. The system also analyzes proposed clause inputs, classifying them according to their clause type and determining their relationship to a family of documents. Furthermore, the system identifies previously utilized legal clauses based on the clause type and agreement type and reformats them to incorporate characteristics associated with the family of documents. This reformatting can involve proposing revisions to pre-existing clauses or introducing new clauses to align with the proposed agreement. Additionally, the system evaluates potential risks associated with the proposed revisions or new clauses, considering predefined risk management parameters or regulatory requirements. This evaluation enables the system to address potential risks by further reformatting the proposed revisions or new clauses.

In some embodiments, the system leverages a private clause library or publicly available information to generate the proposed revised clause language. It may also include a human-in-the-loop process, where the proposed revisions or new clauses are forwarded to a human for manual review before finalization. The system further tailors the proposed revisions or new clauses to specific lines of business associated with a financial institution, as well as to particular financial products or services. User notifications are provided to alert users to potential risk exposures associated with the proposed revisions or new clauses. Additionally, the system can train one or more generative transformers on approved legal clauses, enabling the system to tailor the one or more generative transformers to produce a standardized format for improved efficiency and consistency. The generation of proposed revised clause language may utilize the output of two or more generative transformers, enhancing the quality and variety of suggested language.

User notifications regarding potential risk exposure can be provided, and with the potential of alerting users to identified risk. Risk analysis of proposed revised clause language may utilize the output of two or more generative transformers. By automating the process and incorporating artificial intelligence and machine learning, the system streamlines contract creation, negotiation, and review, while ensuring compliance with regulations and minimizing the organization's exposure to risk.

The disclosed system embodies a technological advancement in the realm of contract management, leveraging artificial intelligence algorithms to efficiently analyze and process large amounts of data at speeds and with a level of accuracy that surpasses human capabilities. The complexity and depth of analysis required in contract management, including activities such as classifying agreements, analyzing clause inputs, and evaluating potential risks, necessitate the utilization of artificial intelligence algorithms. The system's ability to perform these tasks in a nonconventional and non-generic manner demonstrates its practical application and distinguishes it from generic computer implementations.

By employing artificial intelligence algorithms, the system provides a technological solution that goes beyond what the human mind can achieve. The system's ability to process data, make informed decisions, and generate proposed clause language in a manner that exceeds human capabilities demonstrates its practical application and the transformative impact it has on contract management. The utilization of artificial intelligence in a nonconventional manner distinguishes the system from generic computer implementations and firmly grounds it as a technological application in the realm of contract management.

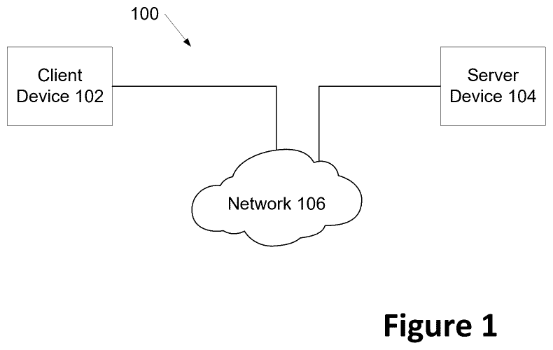

FIG. 1 illustrates a computer system 100 designed for contract management applicable across a wide range of customer service oriented organizations and support domains. In the examples that follow, the organization is a financial institution, involving interactions between customers, individuals, and businesses engaging with financial institutions or other entities that provide financial services.

As depicted in FIG. 1, the computer system 100 encompasses a computing environment comprised of one or more client devices 102 connected to a server device 104 via a network 106. The one or more client devices 102 are computing devices equipped with processors and memory, capable of initiating various tasks related to contract management. These client devices 102 can encompass a variety of computing devices such as desktop computers, laptops, integrated development environment systems, or other hardware capable of interfacing with the components of the network 106.

The server device 104, which may be a single server or a collection of servers within a server farm, possesses computing resources including processors and data storage repositories. This empowers the one or more client devices 102 to engage in contract management tasks. The analytical capabilities of the server device 104 are directed at analyzing data and interactions to facilitate efficient contract management processes.

Although depicted as physically distinct devices, the one or more client devices 102 and the server device 104 can share resources such as processors and databases, enabling a unified approach to analyzing interactions and formulating response strategies. In certain embodiments, the server device 104 may also incorporate resources from a third-party vendor or contracting partner. These resources can include one or more generative pre-trained transformers or other algorithms or features to improve the functionality of the modules and engines described herein.

The network 106 serves as the underlying communication framework, facilitating data exchange and interaction between the one or more client devices 102 and the server device 104. It ensures the reliable and secure exchange of data and commands across the computer system 100, enabling real-time analysis and adaptive responses based on ongoing customer-agent interactions.

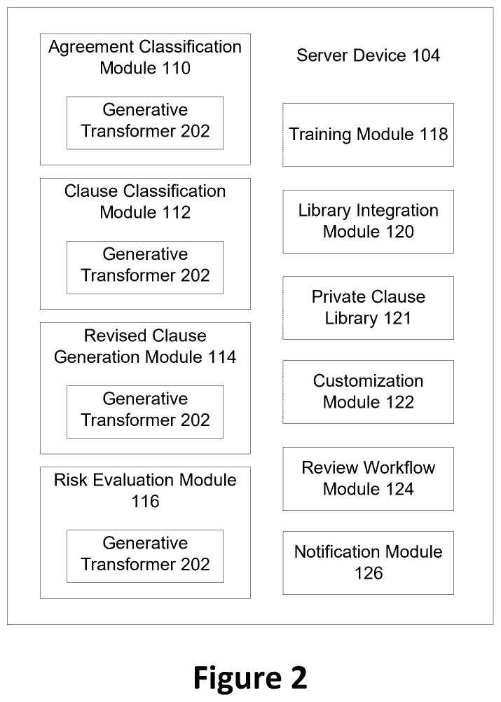

As shown in FIG. 2, the server device 104 can comprise one or more modules, with each module configured as a specialized component adapted to perform specific computational processing tasks within the computer system 100. In certain embodiments, the server device 104 incorporates the following modules: agreement classification module 110, clause classification module 112, revised clause generation module 114, risk evaluation module 116, training module 118, library integration module 120, customization module 122, review workflow module 124, and notification module 126. Together, these modules constitute a comprehensive sub-system within the server device 104, facilitating the efficient suggestion, review and approval of contracts.

The agreement classification module 110, is a component within the server device 104 configured to receive attributes related to a proposed agreement and perform analysis to classify the agreement into a specific agreement type. The agreement classification module 110 can utilize the received attributes, which can include information such as customer identifying information, product information, document type, line of business, and other relevant data points, to determine the appropriate agreement classification.

For example, in the context of a financial institution, the agreement classification module 110 can identify agreement types such as loan agreements, mortgage agreements, credit card agreements, investment agreements, or insurance policies. By examining the attributes associated with a proposed agreement, such as the loan amount, interest rate, and repayment terms, the module can accurately classify it as a loan agreement.

For instance, consider a scenario where a customer applies for a home equity line of credit. The agreement classification module 110 can analyze the attributes associated with the proposed agreement, which may include details like the maximum credit limit, variable interest rate, and the terms of withdrawal and repayment. Based on this information, the agreement classification module 110 can correctly classify the agreement as a home equity line of credit agreement.

The agreement classification module 110 can be configured to recognize a diverse range of agreement types, such as service agreements, lease agreements, employment contracts, or vendor agreements. By considering attributes like service description, duration, payment terms, or parties involved, the agreement classification module 110 can identify the correct agreement type.

To ensure proper classification, in some embodiments, the agreement classification module 110 can provide a notification to the user, prompting them to confirm the agreement's classification. This notification can enable the user to verify that the classification aligns with the intended agreement type, thereby enhancing the accuracy and reliability of the agreement classification process, and reducing the likelihood of misclassification.

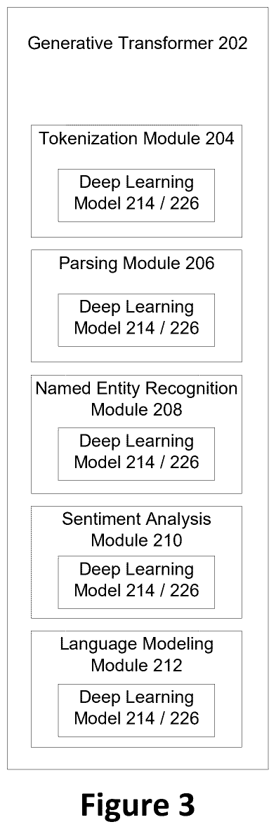

In some embodiments, the agreement classification module 110 can employ a generative pre-trained transformer or other artificial intelligence and machine learning algorithms with natural language processing capabilities, for example as depicted in FIGS. 3-6, to enhance its performance in classifying agreements. These advanced algorithms enable the agreement classification module 110 to process and analyze the textual content of the proposed agreements, extracting meaningful information and patterns, as well as to understand and generate human-like text.

In embodiments, the agreement classification module 110 can apply natural language processing techniques to parse and understand the linguistic elements within the agreements, such as keywords, phrases, and semantic relationships. Through this analysis, the agreement classification module 110 can accurately identify relevant attributes and discern the agreement type.

The clause classification module 112 is a component within the server device 104 that is configured to receive a proposed clause input for the proposed agreement and perform various analyses to classify the clause and determine its relationship to the agreement.

A proposed clause input can be any textual content submitted as part of the agreement creation process. In some cases, the proposed close input may represent a specific clause or term that is being considered for inclusion in the agreement. This can include provisions related to pricing, payment terms, termination clauses, confidentiality obligations, intellectual property rights, and other relevant contractual terms.

To classify the proposed clause input according to its clause type, the clause classification module 112 can utilize natural language processing techniques to analyze the textual content. For example, if the proposed clause input includes language related to payment terms, such as “The payment shall be made in monthly installments,” the module can classify the clause as a Payment Terms clause.

In addition to clause classification, the clause classification module 112 can also determine whether the proposed clause input relates to a family of documents. This determination can be based on the textual content itself, as well as potentially considering the previously determined type of agreement. For instance, if the proposed clause input mentions specific sections of other related documents or refers to terms and conditions applicable to a group of agreements, the clause classification module 112 can identify the proposed clause input as being part of a family of documents.

Furthermore, the clause classification module 112 can assess whether the proposed clause input relates to an amendment to a pre-existing agreement or a new agreement. This determination can be made by analyzing the language used within the proposed clause input. For example, if the proposed clause input refers to modifying or changing specific terms from an existing agreement, it can be classified as an amendment clause. On the other hand, if the clause input introduces entirely new terms without referencing an existing agreement, it can be identified as a new agreement clause.

By performing these analyses, the clause classification module 112 enhances the overall contract management process, ensuring accurate classification of clause types, identification of relationships to document families, and differentiation between amendments and new agreements. This facilitates streamlined and efficient handling of proposed clauses, enabling the system to generate appropriate revised clause language and effectively manage the agreement creation and negotiation process.

In some embodiments, the clause classification module 112 can leverage a generative pre-trained transformer or other artificial intelligence and machine learning algorithms with natural language processing capabilities, for example as depicted in FIGS. 3-6, to enhance its performance in classifying proposed clauses. These advanced algorithms enable the module to analyze the textual content of the clauses, understanding their context and meaning. By utilizing natural language processing techniques, the module can accurately classify the proposed clauses according to their clause types, thereby enhancing the accuracy and efficiency of the clause classification process, facilitating effective decision-making in the agreement creation and negotiation stages.

The revised clause generation module 114 is a component within the server device 104 configured to generate proposed revised clause language for the agreement. The revised clause generation module 114 is configured to perform several tasks, including identifying a previously utilized legal clause based on the clause type and agreement type, reformatting the clause to incorporate characteristics associated with the family of documents, and adjusting the clause to read as either a proposed revision to a pre-existing clause or a proposed new clause to the new agreement.

For example, the revised clause generation module 114 can identify a previously utilized legal clause that is relevant to the clause type and agreement type. This identification can be based on a library of pre-existing legal clauses that have been categorized and associated with specific clause types and agreement types. By retrieving the appropriate previously utilized legal clause, the revised clause generation module 114 can aid in ensuring that the proposed revised clause language aligns with approved legal standards and practices.

In the context of incorporating a characteristic associated with the family of documents, the revised clause generation module 114 can consider other contracts or documents that are associated with or generally belong to the same family as the new agreement. By analyzing these related documents, the revised clause generation module 114 can identify common characteristics, terms, or provisions that should be reflected in the proposed revised clause language, to ensure consistency and coherence across the family of documents, and enhance the overall integrity of the agreements. Additionally, the revised clause generation module 114 can identify the relationship of the proposed agreement to the family of documents.

The output of the revised clause generation module 114 can take the form of a revision or proposed amendment to a pre-existing clause, tailored to the specific terms and conditions negotiated by the parties. Alternatively, the output can be modeled as a proposed new clause to the new agreement, adhering to an approved preferred legal template or format. This approach allows for certain elements, such as standardized or boilerplate language, to be incorporated from the approved template, while other elements are filled in by the revised clause generation module 114 based on the specific terms and conditions negotiated.

As an example, suppose that the revised clause generation module 114 identifies that the proposed clause input pertains to the interest rate calculation, and therefore the recognizes the clause as an Interest Rate Calculation clause. Next, the revised clause generation module 114 can search its database for a previously utilized legal clause that corresponds to the identified clause type and agreement type (in this case, a home mortgage agreement), and retrieve a pre-existing legal clause that addresses the interest rate calculation from its library of mortgage-related clauses.

Thereafter the revised clause generation module 114 can reformat the language to incorporate any characteristics associated with the family of documents, such as specific terms, definitions, or provisions commonly used in mortgage agreements, as well as to adjusts the clause to read as a proposed revision to the pre-existing clause. For example, it may update the interest rate calculation formula to reflect the negotiated terms, adjusting the clause to align with the agreed-upon terms of the home mortgage agreement.

In some embodiments, the revised clause generation module 114 can leverage a generative pre-trained transformer or other artificial intelligence and machine learning algorithms with natural language processing capabilities, as depicted in FIGS. 3-6, to enhance its performance. By employing these advanced algorithms, the revised clause generation module 114 can generate proposed revised clause language by identifying previously utilized legal clauses, incorporating characteristics associated with document families, and adapting the language as either proposed revisions to pre-existing clauses or proposed new clauses.

The risk evaluation module 116 is a component within the server device 104 configured to evaluate the potential risk exposure associated with proposed revisions or new clauses. The risk evaluation module 116 can be configured to analyze the proposed revisions or new clauses and assess their conformity to risk management parameters or regulatory requirements. Based on this evaluation, the risk evaluation module 116 can determine the potential risk exposure and initiate necessary reformatting of the proposed revisions or new clauses to mitigate identified risks.

For example, in one embodiment, the risk evaluation module 116 can utilize an independent generative pre-trained transformer or other artificial intelligence and machine learning algorithms with natural language processing capabilities to verify and approve clause proposals and revisions made by the revised clause generation module 114. By leveraging these advanced algorithms, the risk evaluation module 116 can analyze the proposed revisions or new clauses, ensuring they adhere to risk management parameters and regulatory requirements. This analysis can involve assessing the language, context, and potential implications of the proposed clauses, enabling the module to identify potential risks and evaluate their exposure.

By employing the risk evaluation module 116, organizations can mitigate potential risks and ensure compliance with regulatory requirements. The module's integration of generative pre-trained transformers or other artificial intelligence and machine learning algorithms with natural language processing capabilities enhances the accuracy and efficiency of the risk evaluation process, providing valuable insights to guide the reformatting and adjustment of proposed revisions or new clauses.

The training module 118 is a component within the server device 104 configured to work in conjunction with the library integration module 120 and the customization module 122 to train generative pre-trained transformers or other artificial intelligence and machine learning algorithms. In some embodiments, this training can involve utilizing approved legal clauses that have been converted into a standardized format.

By leveraging a private clause library 121, the training module 118 can enhance the generation of proposed revised clause language. The private clause library 121 can serve as a valuable resource for providing relevant and accurate clauses specific to the lines of business associated with a financial institution. The library integration module 120 utilizes the private clause library 121 to generate proposed revised clause language that aligns with the institution's specific requirements and standards.

In addition to the private clause library 121, the training module 118 can also leverage publicly available information in the generation of proposed revised clause language. This information can enhance the variety and applicability of the proposed language, ensuring that it covers a broad range of scenarios and contractual needs.

Furthermore, the training module 118 can work with the customization module 122 to tailor the proposed revision or new clause to the lines of business associated with a financial institution. By considering the specific requirements and characteristics of each line of business, the training module 118 can generate proposed clause language that is customized and relevant to the respective business domain.

The review workflow module 124 is a component within the server device 104 configured to facilitate the manual review process of proposed revisions or new clauses. The review workflow module 124 can be configured to forward the proposed revision or the proposed new clause to a human reviewer, typically to a legal team or quality control department, for manual review.

Once the proposed revision or new clause is generated by the system 100, the review workflow module 124 can ensure that the proposed clause is appropriately routed to the designated human reviewer for thorough manual inspection and verification. The review workflow module 124 can coordinate the transfer of the proposed clause, providing the necessary context and information to the reviewer to aid in the review process. By involving human reviewers in the process, the review workflow module 124 can allow for a comprehensive assessment of the proposed revisions or new clauses.

The notification module 126 is a component within the server device 104 configured to provide user notifications regarding potential risk exposure associated with the proposed revision or the proposed new clause. The notification module 126 can be configured to analyze the proposed clauses, evaluate the potential risks based on predefined risk management parameters or regulatory requirements, and generate notifications to alert users of the identified risks.

For example, when the system 100 identifies potential risk exposure associated with the proposed revision or new clause, the notification module 126 can trigger the generation of a user notification. This notification can be designed to inform the user about the specific risks identified, providing them with valuable information to make informed decisions. The notification can include details about the nature of the risks, potential consequences, and any recommended actions or modifications to address the risks effectively.

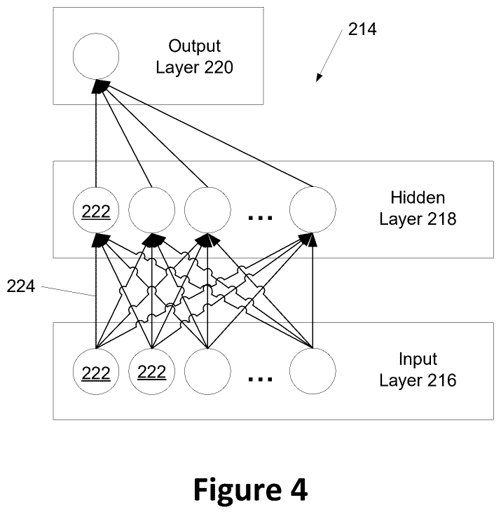

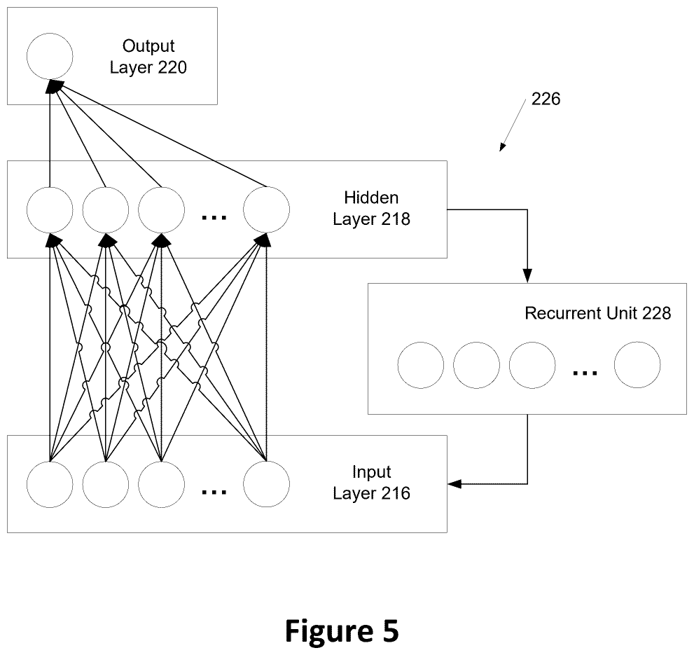

In embodiments, the agreement classification module 110, clause classification module 112, revised clause generation module 114, and risk evaluation module 116 can utilize a generative pre-trained transformer or other artificial intelligence or machine learning algorithms equipped with natural language processing capabilities. Referring to FIG. 3, a generative transformer 202, configured with natural language processing features, is depicted in accordance with an embodiment of the disclosure. The generative transformer 202 can comprise several sub-components including a tokenization module 204, a parsing module 206, a named entity recognition module 208, a sentiment analysis module 210, and a language modeling module 212, each of which can incorporate one or more types of deep learning models, such as feedforward or recurrent models, which are further illustrated in FIGS. 4 and 5.

With continued reference to FIG. 3, the tokenization module 204 can be designed to segment textual data into individual tokens, which may comprise words, sentences, or sub-words. Segmentation can serve as one of the initial steps in text processing, establishing the basic units of language for further analysis and comprehension. For instance, when processing a proposed clause input, the tokenization module 204 can dissect a complex legal sentence into smaller, manageable pieces, such as words and phrases, facilitating detailed syntactic and semantic analysis by subsequent processing modules.

In a practical application, the tokenization module 204 effectively disassembles the text into individual tokens, isolating words, punctuation marks, and numerical values. Each token represents a discrete unit that subsequent modules within the system 100 can further process and analyze. Employing a neural network-based approach allows the tokenization module 204 to handle intricate linguistic patterns, including variations in word forms, complex sentence structures, and diverse punctuation usage, thereby ensuring that downstream components receive well-defined tokens.

Moreover, in certain embodiments, the tokenization module 204 can use one or more deep learning models to decompose text into its constituent tokens, such as words, sentences, or sub-words. This decomposition establishes the primary units of language necessary for subsequent analytical processes, thereby enhancing the efficiency and effectiveness of text processing and comprehension within the system. This capability is particularly advantageous in platforms requiring precise and thorough text analysis.

The parsing module 206 is tasked with the analysis of grammatical structures within sentences, facilitating an understanding of the relationships among words. The parsing module 206 can execute operations such as part-of-speech tagging, syntactic parsing, and dependency parsing. These operations can encompass the assignment of grammatical labels to words, identification of syntactic relationships, and representation of the dependencies among words in a sentence. To fulfill these tasks, the parsing module 206 can utilize advanced deep learning models, including recurrent neural networks or transformer models trained on extensive, labeled datasets to recognize and interpret the complex patterns and structures inherent in human language.

For example, when tasked with parsing a proposed clause input, the parsing module 206 can dissect a legal sentence to determine its syntactic structure by identifying relationships among words and grouping them into phrases or clauses. Specifically, in parsing a clause stating, “The lessee shall maintain insurance coverage,” the parsing module 206 can categorize “The lessee” as the subject, “shall maintain” as the modal verb phrase, and “insurance coverage” as the object, effectively mapping out the sentence structure for further semantic analysis.

Furthermore, the parsing module 206 can be capable of discerning the dependencies among words within a sentence. For instance, in analyzing the phrase “payment shall be made by the borrower,” the module can identify “payment” as the subject, with “shall be made” functioning as the compound verb, and “by the borrower” indicating the agent performing the action, thereby clarifying the grammatical relationships and dependencies. Employing a neural network-based approach, the parsing module 206 can analyze the grammatical structure of sentences and deciphers the relationships among words.

The named entity recognition module 208 can be configured to identify and classify named entities within text, encompassing specific categories such as names of individuals, organizations, locations, dates, and other specialized terminologies. To achieve this, the named entity recognition module 208 can use a deep learning model that is trained on labeled datasets. These datasets can include annotated examples of named entities, which enable the model to learn relevant patterns and features.

For instance, in processing a proposed clause input such as “Under the terms of this loan agreement dated Apr. 15, 2024, between Organization A and John Doe, the borrower agrees to repay the loan over a period of 15 years,” the named entity recognition module 208 can identify “Apr. 15, 2024” as a date, “Organization A” as an organization, and “John Doe” as a person. Following this identification process, the named entity recognition module 208 can then assign the appropriate entity labels to these identified entities, thus facilitating the structured interpretation and further processing of the clause within the system 100.

The sentiment analysis module 210 can be configured to ascertain a sentiment expressed within a given text, facilitating the analysis of the text's emotional tone and its classification as positive, negative, or neutral. To conduct sentiment analysis, the sentiment analysis module 210 can employ a combination of machine learning algorithms, natural language processing techniques, and lexicon-based methods. These methodologies enable the module to detect and interpret sentiment-bearing words, phrases, or patterns in the text, subsequently assigning an appropriate sentiment label.

Additionally, one or more deep learning models incorporated within the sentiment analysis module 210 can feature an attribution mechanism to determine the degree of attention or weight that the models allocate to specific tokens. For instance, consider a proposed clause input in a contract negotiation text: “The client must promptly notify the provider of any dissatisfaction.” The sentiment analysis module 210 can analyze this sentence, identifying key phrases such as “any dissatisfaction.” By recognizing the negative connotations of these words, the module can classify the sentiment of the clause as negative. This capability is particularly valuable in contexts such as legal or customer service environments, where understanding the emotional tone of text can influence decision-making and strategic responses.

The language modeling module 212 can be configured to utilize a neural network-based approach to forecast the likelihood of subsequent words or sequences of words within a given text. The language modeling module 212 can focus on grasping the contextual nuances of text and generating coherent, fluent language that aligns with the patterns and structures discerned in the training data. To execute language modeling tasks, the language modeling module 212 can use deep learning models or analogous architectures designed to capture the sequential dependencies and contextual information embedded within the text.

For example, consider a scenario where the language modeling module 212 is tasked with revising a legal clause from a previous loan agreement to adapt it for a new mortgage agreement. Suppose the original clause states, “The borrower must repay the loan in full within 30 years.” Upon receiving the attributes of the new mortgage agreement which stipulates a 20-year repayment period, the language modeling module 212 can analyze the context and structure of the original clause. Leveraging its trained neural network, the module can predict and generate a revised clause that aligns with the new agreement's terms: “The borrower must repay the mortgage in full within 20 years.” This capability allows the module to automatically generate tailored revisions that meet specific contractual requirements, enhancing efficiency and accuracy in legal document preparation.

Each of the tokenization module 204, parsing module 206, named entity recognition module 208, sentiment analysis module 210, and language modeling module 212 can comprise a deep learning model, for example in the form of one or both of a feedforward model (FFM) 214 (as depicted in FIG. 4), or a recurrent neural network (RNN) 226, (as depicted in FIG. 5).

Referring to FIG. 4, the FFM 214 can include an input layer 216, one or more hidden layers 218, and an output layer 220. Each of these layers, 216, 218, and 220, contains a plurality of neurons 222. Although the illustration shows only a single hidden layer 218, it should be noted that multiple hidden layers 218 may be included in the FFM 214. The inputs for the input layer are typically numerical values ranging between 0 and 1. For instance, the input layer 216 can incorporate one neuron for each potential predictor or causal factor under evaluation, with each neuron's value in the input layer 216 ranging between 0 and 1; however, configurations with varying numbers of neurons and input values are also considered.

As depicted, neurons 222 in one layer, such as the input layer 216, are connected to neurons 222 in a subsequent layer, like the hidden layer 218, through connections 224, establishing a fully connected network architecture. It is also conceivable that the FFM 214 can be structured as a convolutional network, where one or more groups of neurons 222 within a layer are linked to corresponding neurons in a subsequent layer, each group sharing a weighted value.

Each neuron 222 is configured to receive one or more input values (x) and compute an output value (y). In fully connected networks, each neuron 222 is assigned a bias value (b), and each connection 224 is assigned a weight value (w). These weights and biases are adjustable as the FFM 214 learns to identify patterns within the data. The function of each neuron 222 is defined mathematically, where the output y is a function of the weighted sum of inputs and the bias of the neuron.

The output (y) of each neuron 222 in some embodiments can range between 0 and 1. Moreover, the output of each neuron 222 may be determined by various activation functions, including linear, sigmoid, tanh, and rectified linear unit functions, configured to generally inhibit saturation and stabilize the FFM 214.

The output layer 220 may include neurons 222 corresponding to the required number of outputs for the FFM 214. For instance, the output layer 220 might feature a single output neuron, with its output value between 0 and 1 representing the probability of a targeted event occurring. Alternate configurations with different numbers of output neurons are also envisaged; for example, output neurons might correspond to the probability of correct entity recognition in a legal document.

The primary objective of the deep learning algorithm is to fine-tune the weights and biases of the FFM 214 until the inputs at the input layer 216 are accurately mapped to the desired outputs at the output layer 220, thus enabling the FFM 214 to reliably produce outputs (y) for previously unseen inputs (x). For instance, with data procured by the tokenization module 204 fed into the input layer 216, an expected outcome of the FFM 214 can be to indicate the probability of the text representing a specific legal term or clause.

In optimizing the FFM 214, a cost function, such as a quadratic cost function or cross entropy, is employed to gauge how closely the actual outputs of the output layer 220 match the known outputs from the training data. Each complete pass of the FFM 214 through the training dataset is referred to as one epoch. Over multiple epochs, the weights and biases of the FFM 214 are progressively adjusted to iteratively minimize the cost function.

Effective optimization of the FFM 214 is achieved by executing a gradient descent on the cost function, aiming to locate a global minimum. A backpropagation algorithm is utilized to compute the gradient descent of the cost function, calculating the partial derivatives of the cost function with respect to any weight (w) or bias (b) in the FFM 214. This algorithm facilitates tracking minor adjustments to the weights and biases as they propagate through the network, influence the output, and affect the cost. To prevent overfitting of the FFM 214, changes to weights and biases can be constrained by a learning rate, set between approximately 0.03 and 10. Furthermore, methods of regularization, such as L1 and L2 regularization, may also be applied to aid in minimizing the cost function.

In feedforward models, information flows unidirectionally from the input layer to the output layer without any cycles or loops. By contrast, as depicted in FIG. 5, a recurrent neural network (RNN) 226 enables data from a prior hidden state to be reintroduced into the network's layers, providing the network with a form of memory. This characteristic allows the RNN to maintain information across different points in a sequence, leveraging past insights to influence future outputs.

Unlike feedforward neural networks that process each input independently, the RNN's architecture with its hidden states enables it to store and utilize information from previous steps or time points in the sequence, effectively giving it a memory.

A defining feature of RNN 226 is its recurrent unit 228, which form loops within the network architecture, allowing information to circulate from one time step to the next. These recurrent unit 228 loops enable the network to capture the context and temporal dependencies within a sequence, with the hidden state acting as a dynamic memory that retains essential information from previous steps to influence subsequent data processing.

In RNN 226, each sequence step can correspond to a specific time point, and the input at each time step is integrated with the hidden state from the previous step to generate an output while simultaneously updating the hidden state. This process can involve sharing the same set of weights across all time steps, which allows the network to detect and learn patterns and relationships that recur at various points in the sequence.

To enhance the ability of the neural network to capture long-term dependencies and retain information over extended sequences, advanced variants of RNNs, such as Long Short-Term Memory (LSTM) units and Gated Recurrent Units (GRUs), can be utilized. These variants incorporate specialized gating mechanisms that regulate the flow of information within the network, ensuring that relevant data is preserved and irrelevant data is discarded, thereby improving the network's efficiency and effectiveness in handling complex sequences.

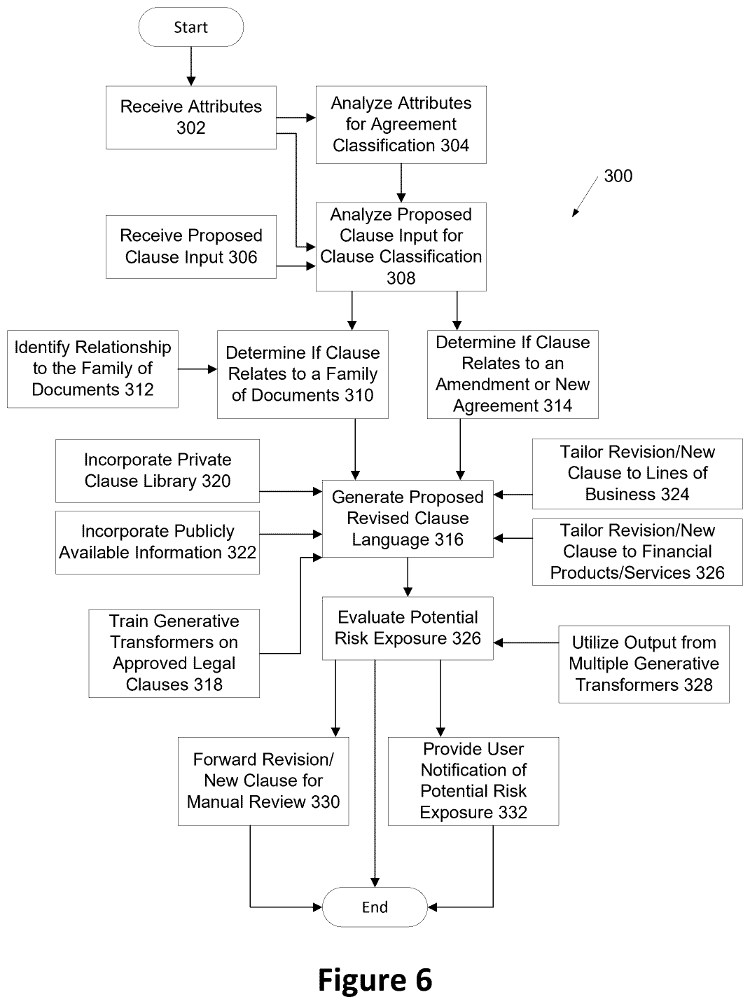

Referring to FIG. 6, an example method 300 is shown for managing contracts, presented in accordance with the disclosed embodiments. The method 300 comprises a sequence of steps for managing legal contracts within a computer system. In some embodiments, the method 300 can be implemented by the system 100.

At step 302, the method 300 can begin by receiving attributes associated with a proposed contract. These attributes can be analyzed at step 304 to classify the agreement according to a type. For example, the agreement classification module 110 can classify or predict a type of the proposed contract, such as a loan agreement, mortgage agreement, credit card agreement, investment agreement, insurance policy, or other type of contract. Note that in certain embodiments, steps 302 and 304 can be performed by the agreement classification module 110.

Continuing to step 306, the method 300 can proceed with the receipt of a proposed clause input, which in some embodiments can be concurrently performed with step 302. At step 308, the proposed clause input, potentially along with the received attributes and the analysis of the received attributes, can be analyzed to predict or determine the classification or type of clause that the system 100 will propose or amend (e.g., termination clause, warranty clause, governing law clause, etc.). The analysis considers various factors such as the language used, the context within the agreement, and the legal requirements, ensuring accurate and appropriate classification of the proposed clause. Note that in some embodiments, steps 306 and 308 can be performed by the clause classification module 112.

At step 310, the method 300 proceeds to determine whether the proposed clause relates to a family of documents. This determination can involve analyzing the received attributes or proposed clause input to identify any shared characteristics, terms, or provisions that align the proposed contract with other related documents. Continuing to step 312, if a relationship to a family of documents is established, the system can determine if the proposed contract is a continuation or extension of a previously existing agreement, supplementing it with additional terms or provisions. At step 314, the method 300 can proceed to determine whether the proposed clause input relates to an amendment for an existing agreement or pertains to a new clause for a new agreement.

In some embodiments, steps 310, 312, and 314 can be managed by the clause classification module 112, which ensures precise identification of the clause's relation to the family of documents and determines whether it represents an amendment or a new clause.

For instance, the proposed contract can be identified as either an amendment or a new document based on attributes such as account number, product request ID, agreement name, legal entity name, origination date, maturity date, terms effective date, and principal amount. Any affiliation with the proposed contract affiliation-whether it has a single family association or a multi-family association-can be determined by matching one or more key attributes with documents previously validated, potentially through a manual, human-in-the-loop review.

In certain embodiments, method 300 can use predefined rules tailored to various lines and sub-lines of business to assign each proposed contract to an agreement type, thus forming a family based on the specified attributes. For example, proposed contracts can be categorized into levels, including: Level-1 for Master agreements, Level-2 for Additional supporting documents, and Level-3 for Amendments. Standalone agreements without family associations can be designated accordingly.

If a primary attribute (e.g., the account number, etc.) is present, associated documents can be grouped into one family with a 100% confidence score. In the absence of primary attributes, other attributes can be used for matching, yielding confidence scores of 80%-90%, depending on whether exact or fuzzy matching is applied.

Furthermore, within each family, a proposed contract can be categorized as Level-1 (e.g., parent document), with Levels 2 and 3 representing subsidiary documents. The existence of a parent document suggests that a completeness check is passed. For example, if an incoming document aligns with the key attributes of more than one validated family, the proposed contract is considered a multi-family association, which can prompt a human-in-loop review process to update the family. Conversely, if the proposed contract matches with a single validated family, the proposed contract can be validated to bypass further review.

At step 316, the method 300 proceeds to generate proposed revised clause language. For example, step 316 can be implemented by the revised clause generation module 114, which can identify a previously utilized legal clause that corresponds to the clause type and the agreement type. Step 316 then reformats the previously utilized legal clause to incorporate a characteristic associated with the family of documents. Step 316 can further reformat the clause to read as either a proposed revision to a pre-existing clause of the pre-existing agreement or a proposed new clause to the new agreement to ensure that the proposed clause language aligns with the characteristics of the family of documents and meets the requirements of the specific agreement.

At step 318, the method 300 can include training an AI algorithm on approved legal clauses to generate the proposed revised clause language mentioned in step 316. The training process at step 318 can enable the AI algorithm to learn from a collection of vetted and validated legal clauses, enhancing its ability to generate accurate and appropriate language for proposed revisions.

In some embodiments, step 318 can further involve step 320, where a private clause library is incorporated. This library can include a comprehensive collection of approved clauses organized by agreement and clause type. The library can serve as a resource for generating proposed revised clause language that is adaptable to a variety of situations.

Additionally, in some embodiments, step 322 may be implemented to incorporate publicly available information, which can involve referencing books or treatises on legal clause drafting, utilizing lookup tables for financial metrics, or scraping information from various websites and publicly accessible databases. These sources can provide additional guidance and references to ensure the accuracy and relevance of the proposed revised clause language.

At step 324, the training of the artificial intelligence algorithm, as part of method 300, can extend to tailor revisions or the generation of new clauses specifically to promote particular lines of business. In particular, step 324 can involve configuring the algorithm to recognize and prioritize elements important to the strategic interests and regulatory requirements unique to each line of business to produce legal clauses that not only adhere to legal standards but also align with business objectives.

Concurrently, at step 326, the AI training process can be refined to ensure that revisions or new clause generation are particularly relevant to specific financial products or services. This can involve programming the AI to understand and integrate the nuances and specifics of different financial products or services into the legal clauses it generates. The AI algorithm can be taught to consider factors such as the typical contract structures, terms commonly negotiated, and frequent legal challenges associated with each product or service.

At step 326, the method 300 can include evaluation of a potential risk exposure associated with the proposed revision or the introduction of a new clause. This evaluation can be conducted based on one or more risk management parameters or regulatory requirements pertinent to the specific context of the contract or clause under consideration. The risk management parameters can include, but are not limited to, legal compliance risks, financial risks, operational risks, and reputational risks inherent in the language or stipulations of the proposed clause.

During this step, method 300 employs advanced analytics to scrutinize the content of the proposed clause against established risk assessment models and regulatory compliance frameworks. Further at step 328, in some embodiments, a separate and independent artificial intelligence algorithm can be used to crosscheck the outputs of the generative transformer utilized in step 316. This dual-algorithm approach can ensure a robust verification process, where the secondary AI algorithm assesses any elements within the clause that might expose the organization to legal penalties, financial losses, operational hindrances, or reputational damage. This comprehensive risk assessment helps to ensure that the proposed clause is thoroughly examined for compliance and potential liabilities.

At step 330, following the identification of potential risk exposures in step 326, the method 300 can introduce a controlled escalation process wherein the proposed revision or new clause is forwarded to a manual reviewer for further scrutiny. The manual review can be conducted by a legal professional or risk management expert. At step 326, the manual reviewer can assess the proposed language, evaluate the risk implications in detail, and provide recommendations or direct modifications to ensure that the revised or new clause aligns with legal standards, regulatory compliance, and organizational risk tolerance.

Concurrently or alternatively, at step 332, the system 100 can be equipped to issue alerts or notifications concerning the potential risk exposure detected in the proposed revisions or new clauses. These notifications can serve as a proactive measure to inform relevant stakeholders, including legal advisors, contract managers, and business executives, about the risks identified. The alerts can include detailed information on the nature of the risk, its potential impacts, and suggested actions or considerations, enabling timely decision-making and ensures that all parties involved are aware of and can respond appropriately to the risks presented by the proposed legal modifications.

As illustrated in the embodiment of FIG. 6, the example server device 104, which provides the functionality described herein, can include at least one central processing unit (“CPU”) 402, a system memory 408, and a system bus 420 that couples the system memory 408 to the CPU 402. The system memory 408 includes a random access memory (“RAM”) 310 and a read-only memory (“ROM”) 412. A basic input/output system containing the basic routines that help transfer information between elements within the computer system 100, such as during startup, is stored in the ROM 412. The computer system 100 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 420. The mass storage device 414 and its associated computer-readable data storage media provide non-volatile, non-transitory storage for the computer system 100. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 104.

According to various embodiments of the invention, the computer system 100 may operate in a networked environment using logical connections to remote network devices through network 108, such as a wireless network, the Internet, or another type of network. The network 108 provides a wired and/or wireless connection. In some examples, the network 108 can be a local area network, a wide area network, the Internet, or a mixture thereof. Many different communication protocols can be used.

The server device 104 may connect to network 108 through a network interface unit 404 connected to the system bus 420. It should be appreciated that the network interface unit 404 may also be utilized to connect to other types of networks and remote computing systems. The server device 104 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 104 can store software instructions and data. The software instructions include an operating system 418 suitable for controlling the operation of the server device 104. The mass storage device 414 and/or the RAM 410 also store software instructions and applications 416, that when executed by the CPU 402, cause the server device 104 to provide the functionality of the computer system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for a managing a contract, comprising:
receiving attributes regarding a proposed agreement;
analyzing the attributes to classify the proposed agreement according to an agreement type;
receiving a proposed clause input for the proposed agreement;
analyzing the proposed clause input, including:
classifying the proposed clause input according to a clause type;
determining whether the proposed clause input relates to a family of documents; and
determining whether the proposed clause input relates to an amendment to a pre-existing agreement or a new agreement;
generating proposed revised clause language, including:
identifying a previously utilized legal clause according to the clause type and the agreement type;
reformatting the previously utilized legal clause to incorporate a characteristic associated with the family of documents; and
reformatting the previously utilized legal clause to read as either a proposed revision to a pre-existing clause of the pre-existing agreement or a proposed new clause to the new agreement;
evaluating a potential risk exposure associated with the proposed revision or the proposed new clause based on at least one of a risk management parameter or a regulatory requirement; and
reformatting the proposed revision or the proposed new clause to address the potential risk exposure.

2. The method of claim 1, further comprising leveraging a private clause library in generating the proposed revised clause language.

3. The method of claim 1, further comprising leveraging a publicly available information in generating the proposed revised clause language.

4. The method of claim 1, further comprising forwarding the proposed revision or the proposed new clause to a human for manual review.

5. The method of claim 1, further comprising identifying a relationship of the proposed agreement to the family of documents.

6. The method of claim 1, further comprising tailoring the proposed revision or the proposed new clause to one or more lines of business associated with a financial institution.

7. The method of claim 1, further comprising tailoring the proposed revision or the proposed new clause to one or more financial products or services.

8. The method of claim 1, further comprising providing a user notification regarding the potential risk exposure associated with the proposed revision or the proposed new clause.

9. The method of claim 1, further comprising training one or more generative transformers on approved legal clauses converted into a standardized format.

10. The method of claim 1, wherein generating the proposed revised clause language utilizes an output of two or more generative transformers.

11. A computer system for managing a contract, comprising:
one or more processors; and
non-transitory computer-readable storage media encoding instructions which, when executed by the one or more processors, cause the computer system to:
receive attributes regarding a proposed agreement;
analyze the attributes to classify the proposed agreement according to an agreement type;
receive a proposed clause input for the proposed agreement;
analyze the proposed clause input, including:
classify the proposed clause input according to a clause type;
determine whether the proposed clause input relates to a family of documents;
determine whether the proposed clause input relates to an amendment to a pre-existing agreement or a new agreement;
generate proposed revised clause language, including:
identify a previously utilized legal clause according to the clause type and the agreement type;
reformat the previously utilized legal clause to incorporate a characteristic associated with the family of documents;
reformat the previously utilized legal clause to read as either a proposed revision to a pre-existing clause of the pre-existing agreement or a proposed new clause to the new agreement;
evaluate a potential risk exposure associated with the proposed revision or the proposed new clause based on at least one of a risk management parameter or a regulatory requirement; and
reformat the proposed revision or the proposed new clause to address the potential risk exposure.

12. The computer system of claim 11, wherein the computer system is further configured to leverage a private clause library in generating the proposed revised clause language.

13. The computer system of claim 11, wherein the computer system is further configured to leverage publicly available information in generating the proposed revised clause language.

14. The computer system of claim 11, wherein the computer system is further configured to forward the proposed revision or the proposed new clause to a human for manual review.

15. The computer system of claim 11, wherein the computer system is further configured to identify a relationship of the proposed agreement to the family of documents.

16. The computer system of claim 11, wherein the computer system is further configured to tailor the proposed revision or the proposed new clause to one or more lines of business associated with a financial institution.

17. The computer system of claim 11, wherein the computer system is further configured to tailor the proposed revision or the proposed new clause to one or more financial products or services.

18. The computer system of claim 11, wherein the computer system is further configured to provide a user notification regarding the potential risk exposure associated with the proposed revision or the proposed new clause.

19. The computer system of claim 11, wherein the computer system is further configured to enable training of one or more generative transformers on approved legal clauses converted into a standardized format.

20. The computer system of claim 11, wherein the computer system is further configured to utilize an output of two or more generative transformers in generating the proposed revised clause language.
